(19) United States
(12) Patent Application Publication
(10) Pub. No.: US 2025/0158684 A1
(43) Pub. Date: May 15, 2025

(54) SYSTEMS AND METHODS OF ADAPTIVE FREQUENCY HOPPING

(71) Applicant: Meta Platforms Technologies, LLC, Menlo Park, CA (US)

(72) Inventors: Carlos Horacio Aldana, Mountain View, CA (US); Connor Kennedy, San Francisco, CA (US); Kanji Mavji Kerai, London (GB); Muhammad Kumail Haider, Sunnyvale, CA (US); Guoqing Li, Cupertino, CA (US); Davide Magrin, Villa del Conte (IT); Sam Padinjaremannil Alex, Dublin, CA (US)

(73) Assignee: Meta Platforms Technologies, LLC, Menlo Park, CA (US)

(21) Appl. No.: 18/915,014

(22) Filed: Oct. 14, 2024

Related U.S. Application Data
(63) Continuation of application No. 63/598,773, filed on Nov. 14, 2023.

(51) Int. Cl. H04B 7/06; H04B 1/713; H04L 41/5009; H04W 84/12

(52) U.S. Cl. CPC H04B 7/0626; H04B 1/713; H04L 41/5009; H04W 84/12

(57) ABSTRACT

Systems and methods for adaptive frequency hopping may include a wireless communication device which performs, via a wireless communication technology of a plurality of wireless communication technologies supported by the wireless communication device, an initial channel assessment across a plurality of channels. The wireless communication device may generate a channel map for the plurality of channels, for identifying a channel state for the plurality of channels, based on a comparison of one or more metrics for the channels as compared to one or more key performance indicator (KPI) metrics set according to the wireless communication technology. The wireless communication device may occupy a channel, of the plurality of channels, based on the channel state of the channel in the channel map.

### CROSS-REFERENCE TO RELATED APPLICATIONS

This application claims the benefit of and priority to U.S. Provisional Application No. 63/598,773, filed Nov. 14, 2023, the contents of which are incorporated herein by reference in their entirety.

### FIELD OF DISCLOSURE

The present disclosure is generally related to wireless communication between devices, including but not limited to, systems and methods for adaptive frequency hopping.

### BACKGROUND

Augmented reality (AR), virtual reality (VR), and mixed reality (MR) are becoming more prevalent, which such technology being supported across a wider variety of platforms and devices. Some AR/VR/MR devices may communicate with other devices within an environment, where such communication is provided via a channel or link between the devices. As part of establishing the connection, the devices may identify availability of the channel or link.

### SUMMARY

In one aspect, this disclosure relates to a method, including: performing, by a wireless communication device, an initial channel assessment across a plurality of channels, using a wireless communication technology of a plurality of wireless communication technologies supported by the wireless communication device; generating, by the wireless communication device, a channel map for the plurality of channels, identifying a channel state for the plurality of channels, based on a comparison of one or more metrics for the channels as compared to one or more key performance indicator (KPI) metrics set according to the wireless communication technology; and/or occupying, by the wireless communication device, a channel, of the plurality of channels, based on the channel state of the channel in the channel map.

In some embodiments, the method includes selecting, by the wireless communication device, the wireless communication technology from the plurality of wireless communication technologies supported by the wireless communication device, to perform the initial channel assessment. In some embodiments, the plurality of wireless communication technologies includes at least one of a 20 megahertz (MHz) wireless local area network (WLAN) communication technology, a first personal area network (PAN) technology, or a second PAN technology. In some embodiments, the first PAN technology supports 2.5 MHz communication, and the second PAN technology supports at least one of 2 MHz communication or 4 MHz communication. In some embodiments, the one or more KPI metrics include one or more first KPI metrics for a first wireless communication technology and set according to a fixed metric, and one or more second KPI metrics for a second wireless communication technology and set according to the fixed metric. In some embodiments, the method further includes determining, by the wireless communication device, the one or more KPI metrics according to the fixed metric, based on a type of the wireless communication technology selected to perform the initial channel assessment.

In some embodiments, the channel state is identified from a plurality of channel states including an occupied channel state, a potentially occupied channel state, or an available channel state. In some embodiments, the channel state for a respective channel is identified as an occupied channel state, responsive to at least one of: the one or more metrics for the respective channel indicating interference being detected on the respective channel, a count of nearest neighbor narrowband channel (NNC) having respective metrics indicating interference being detected satisfying a first threshold criterion, or a count of consecutive ranging failures satisfying a second threshold criterion.

In some embodiments, the wireless communication device includes a central device, and the method further includes transmitting, by the central device, the channel map to one or more peripheral devices communicably coupled to the central device. In some embodiments, the method further includes: determining, by the wireless communication device, for a first subset of channels of the plurality of channels having a potentially occupied channel state, and for a second subset of channels of the plurality of channels having an available channel state, to perform one or more subsequent channel assessments; performing, by the wireless communication device, for the first subset and the second subset, one or more subsequent channel assessments; and/or updating, by the wireless communication device, the channel map according to the one or more subsequent channel assessments. In some embodiments, the method further includes, after a predetermined duration following designation of one or more channels of the plurality of channels as having an occupied channel state, performing, by the wireless communication device, one or more subsequent channel assessments for the one or more channels; and/or updating, by the wireless communication device, the channel map according to the one or more subsequent channel assessments.

In another aspect, this disclosure is directed to a wireless communication device, including: one or more wireless transceivers configured to support one or more of a plurality of wireless communication technologies; and one or more processors configured to: perform, using the one or more transceivers, via a wireless communication technology of the plurality of wireless communication technologies, an initial channel assessment across a plurality of channels; generate a channel map for the plurality of channels, identify a channel state for the plurality of channels, based on a comparison of one or more metrics for the channels as compared to one or more key performance indicator (KPI) metrics set according to the wireless communication technology; and/or occupy, via the one or more transceivers, a channel, of the plurality of channels, based on the channel state of the channel in the channel map.

In some embodiments, the one or more processors are configured to select the wireless communication technology from the plurality of wireless communication technologies supported by the wireless communication device, to perform the initial channel assessment. In some embodiments, the plurality of wireless communication technologies includes at least one of a 20 megahertz (MHz) wireless local area network (WLAN) communication technology, a first personal area network (PAN) technology, or a second PAN technology. In some embodiments, the first PAN technology supports 2.5 MHz communication, and the second PAN technology supports at least one of 2 MHz communication or 4 MHz communication. In some embodiments, the one or more KPI metrics include one or more first KPI metrics for a first wireless communication technology and set according to a fixed metric, and one or more second KPI metrics for a second wireless communication technology and set according to the fixed metric. In some embodiments, the channel state is identified from a plurality of channel states including an occupied channel state, a potentially occupied channel state, or an available channel state.

In some embodiments, the channel state for a respective channel is identified as an occupied channel state, responsive to at least one of: the one or more metrics for the respective channel indicating interference being detected on the respective channel, a count of nearest neighbor narrowband channel (NNC) having respective metrics indicating interference being detected satisfying a first threshold criterion, or a count of consecutive ranging failures satisfying a second threshold criterion. In some embodiments, the wireless communication device includes a central device, and the one or more processors are configured to: transmit, via the one or more transceivers, the channel map to one or more peripheral devices communicably coupled to the central device.

In yet another aspect, this disclosure relates to a non-transitory computer readable medium storing instructions that, when executed by one or more processors, cause the one or more processors to: perform, via a wireless communication technology of a plurality of wireless communication technologies supported by a wireless communication device, an initial channel assessment across a plurality of channels; generate a channel map for the plurality of channels, identifying a channel state for the plurality of channels, based on a comparison of one or more metrics for the channels as compared to one or more key performance indicator (KPI) metrics set according to the wireless communication technology; and/or occupy a channel, of the plurality of channels, based on the channel state of the channel in the channel map.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for adaptive frequency hopping, according to an example implementation of the present disclosure.

FIG. 6 is a state diagram showing selection between different channel states, according to an example implementation of the present disclosure.

FIG. 7 is a flowchart showing an example method of generating a channel map based on detected metric(s), according to an example implementation of the present disclosure.

FIG. 8 is a flowchart showing an example method of adaptive frequency hopping, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

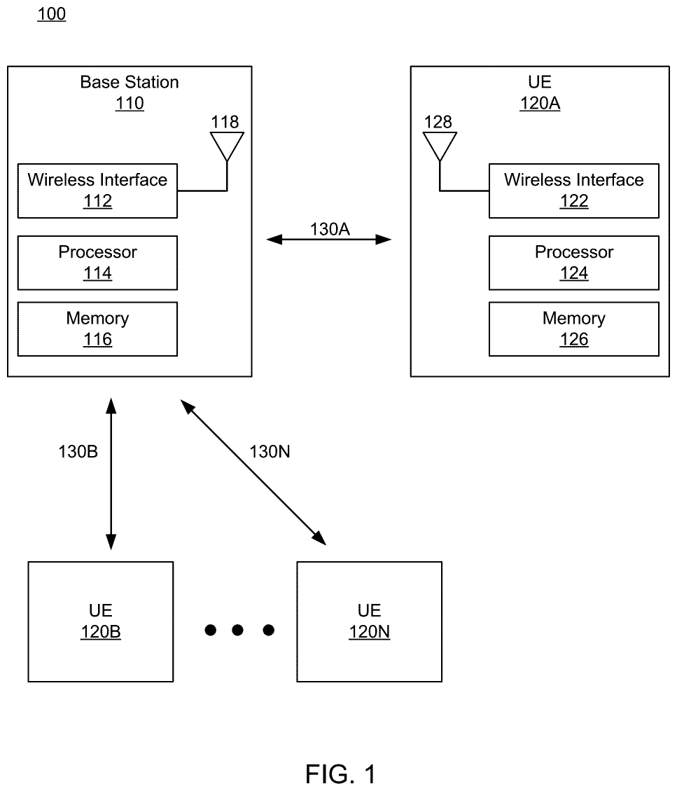

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

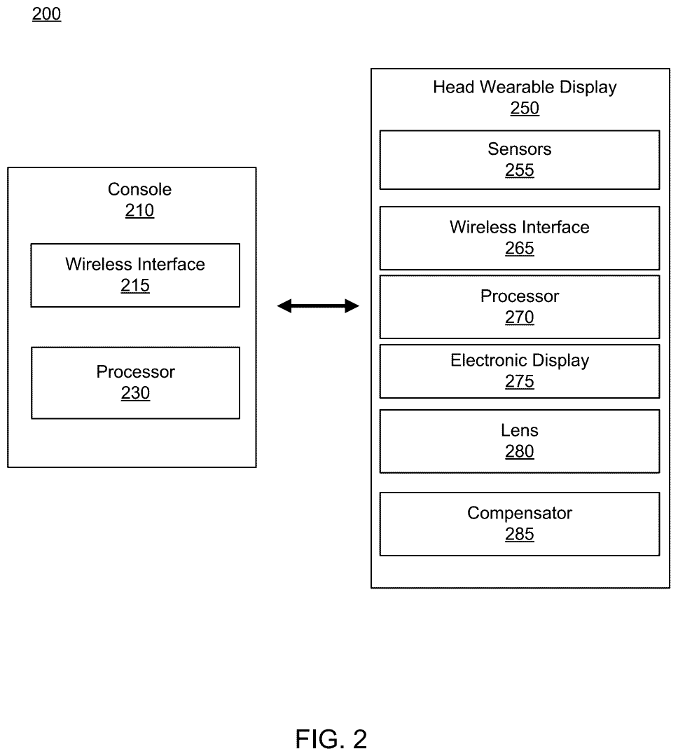

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

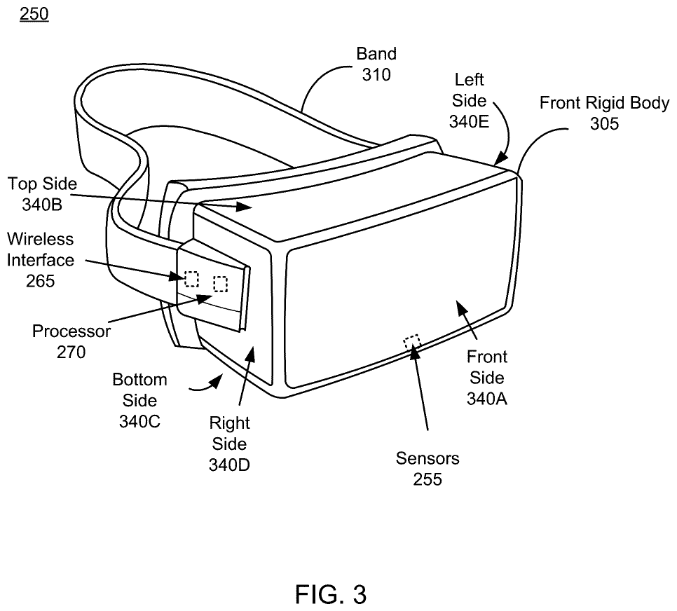

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

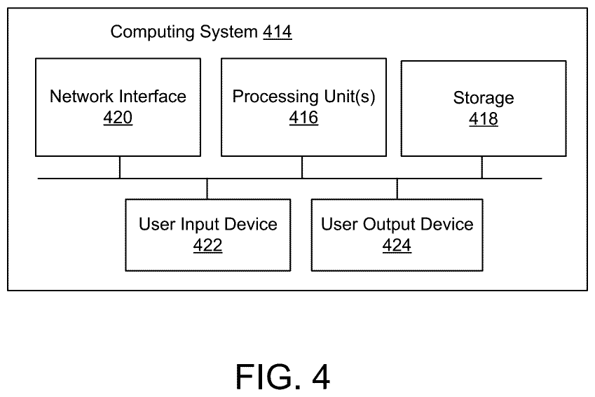

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Disclosed herein are related to systems and methods for adaptive frequency hopping. As part of establishing a connection between two devices, an initiator device may perform a scan of various channels and/or can perform frequency hopping. According to the systems and methods described herein, a device may perform a scan according to a pre-defined scanning policy, such that the scanning duration and determination of availability of a respective channel is defined and testable.

Some Narrowband technologies (e.g., BLUETOOTH) may solely rely on frequency hopping to avoid collisions with other Narrowband or Wideband technologies. BLUETOOTH SIG has an optional adaptive frequency hopping (AFH) feature that blacklists the “bad” channels and allows frequency hopping to occur on the “good” channel. How this blacklisting is done is outside the scope of the standard. There are different ways to make this assessment. Passive scanning listens to a set of channels and determines, via received signal strength indicator (RSSI) measurements or other channel measurements/metrics, which are occupied and which are not. Active scanning, on the other hand, transmits signals regardless of whether the channel is busy or not, and makes a decision based on packet error rate or bit error rate a-posteriori information. Some proposed solutions include doing LBT before every transmission. For the XR use case, this amounts to ˜1000 LBTs per second. Depending on how long the listen interval is, this could greatly increase the power consumption.

The proposed low power solution is to allocate a long window at the beginning to make an accurate assessment of which channels are occupied and which are not. Once steady state is reached, the long window can be shortened to accommodate different traffic conditions. A state diagram may be implemented/proposed in which channels are classified as “good”, “bad”, or “potential”. In addition to the new state diagram, knowledge of Wi-Fi 20 MHz channelization is used to aid the classification.

According to the systems and methods described herein, before entering a first ranging round, each channel may be marked as “available”, and a device (e.g., an initiator/central device and/or a responder/peripheral device) may perform a passive scan of each of the channels (e.g., each UNII-3, UNII-4, and/or UNII-5 channel). To capture aperiodic or bursty traffic, the scan duration of each channel may be set as function of the burst frequency. If the energy detected over a channel satisfies a threshold criteria, the initiator device may label the channel as unavailable. Additionally, the device may label channel whole sets or segments as unavailable based on a certain percentage of segments being determined or labeled as unavailable. Once a channel is labeled as unavailable, the channel may remain unavailable for a set duration.

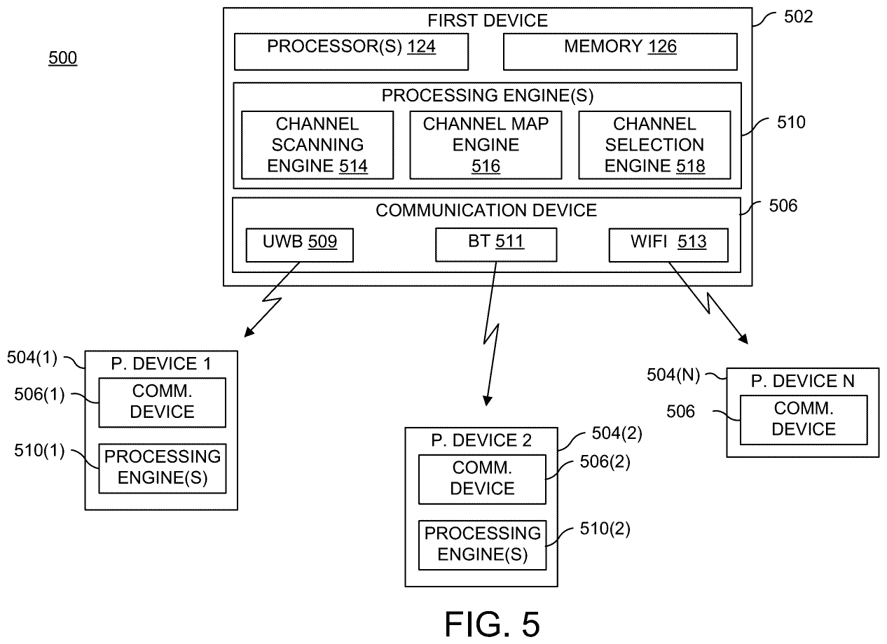

Referring now to FIG. 5, depicted is a block diagram of a system 500 for frequency sharing, according to an example implementation of the present disclosure. The system 500 may include a first device 502 and one or more peripheral devices 504(1)-504(N) (referred to generally as peripheral device 504 or peripheral devices 504). The first device 502 and peripheral devices 504 may be similar to the devices, components, elements, or hardware described above with reference to FIG. 1-FIG. 4. For example, the devices 502, 504 may be similar to the UEs 120, console 210, head wearable display 250, or any other type or form of user equipment. The devices 502, 504 may include components, elements, hardware, etc. similar to the devices described above, such as processor(s) 124, memory 126, etc. While shown as included on the first device 502, it is noted that the peripheral devices 504 may include similar hardware as depicted in the first device 502 (e.g., the peripheral devices 504 may include processor(s) 124, memory 126, and so forth).

The first device 502 and peripheral device(s) 504 may include a respective communication device 506 including or supporting various wireless communication technology or technologies. For example, the communication device 506 may be configured to support wireless personal area network (WPAN) communication via one or more WPAN antennas, devices, or transceivers (e.g., a ultra wideband (UWB) transceiver 509, and/or 2.4/5/6 GHz transceiver, such as a BLUETOOTH (BT) transceiver 511). As another example, the communication device 506 may be configured to support wireless local area network (WLAN) communication via one or more WLAN antennas or transceivers (e.g., WI-FI transceiver 513). WPAN communication may include or involve 2 megahertz (MHz) channel scanning, 2.5 MHz channel scanning, and/or 4 MHz channel scanning. For example, communication via a UWB transceiver 509 may include 2.5 MHz channel scanning (e.g., the UWB transceiver 509 may be or include, or facilitate narrowband assisted (NBA) UWB communication). As another example, communication via the BT transceiver 511 may include or involve 2 MHz or 4 MHz channel scanning. The WI-FI transceiver 513 may include or involve 20 MHz (or larger) channel scanning.

As described in greater detail below, a device (such as the first device 502 and/or any of the peripheral devices 504) may be configured to perform an initial channel assessment across a plurality of channels. The device 502, 504 may be configured to perform the initial channel assessment using a wireless communication technology (e.g., supported by the communication device 506). The device 502, 504 may be configured to generate a channel map for the plurality of channels, identifying a channel state, based on a comparison of one or more metrics of the channels as compared to one or more key performance indicator (KPI) metrics set according to the wireless communication technology (e.g., used to perform the scan). The device 502, 504 may be configured to occupy a channel based on the channel state of the channel in the channel map.

The first device 502 and peripheral device(s) 504 may include one or more processing engine(s) 510. The processing engine(s) 510 may be or include any device, component, element, or hardware designed or configured to perform one or more functions described herein. The processing engine(s) 510 may include a channel scanning engine 514, a channel map engine 516, and a channel selection engine 518. While these processing engine(s) 510 are shown and described, it is noted that fewer and/or additional processing engine(s) 510 may be deployed on, provided on, or otherwise included in the respective devices 502, 504. For example, one processing engine 510 may be divided into multiple processing engines 510, and/or two or more processing engine(s) 510 may be combined and incorporated as a single processing engine 510. Additionally, while shown as being included on the first device 502 (and peripheral devices 504), it is noted that, in some embodiments, the processing engine(s) 510 may be hardware of the communication device 506 of the first device 502 and/or hardware of the transceiver(s) of the communication device 506.

The first device 502 may include a channel scanning engine 514. The channel scanning engine 514 may be designed or configured to initiate, configure, trigger, perform, or otherwise cause performance of an initial channel assessment across a plurality of channels (e.g., of a frequency spectrum). The frequency spectrum may be or include a frequency range which may be occupied (or potentially occupied) by neighboring devices which are using/communicating via a WLAN connection/technology. In some embodiments, the channel scanning engine may be configured to perform the initial channel assessment across sub-channels of the plurality of channels. For example, the plurality of channels may be 20 MHz channels (though other frequency bandwidths may be used, such as 40 MHz, 80 MHz, 160 MHz, and so forth), including a plurality of respective sub-channels (or sub-carriers).

In some embodiments, the channel scanning engine 514 may be configured to perform the initial channel assessment across the channels, prior to any ranging, signaling, or other communication on a given channel. The channel scanning engine 514 may be configured to perform the initial channel assessment across a plurality of channels, ranging between 5150 and 5250 MHz (e.g., UNII-1), between 5,725 MHz and 5,850 MHz (e.g., UNII-3), between 5850 and 5895 MHz (e.g., UNII-4), between 5,925 MHz and 6,425 MHz (e.g., UNII-5), and/or any other frequency spectrums. In some embodiments, the channel scanning engine 514 may be configured to perform the initial channel assessment across a plurality of WLAN channels (e.g., channels which may be used or occupied by a neighboring WLAN device, or a device which is using/communicating via WLAN technology). The channel scanning engine 514 may be configured to perform the initial channel assessment, to determine/detect/identify any potentially occupied, occupied, and/or available channels within the frequency band.

In some embodiments, the channel scanning engine 514 may be configured to select a wireless communication technology in which to perform the initial channel assessment. Where the device 502, 504 supports a single wireless communication technology (e.g., only WLAN communication technology, only WPAN communication technology, and so forth), the channel scanning engine 514 may be configured to select the wireless communication technology based on which technology is supported by the device. Where the device 502, 504 supports multiple wireless communication technologies (e.g., a combination of any of the wireless communication technologies described herein or that may otherwise be implemented on or supported by the devices 502, 504), the channel scanning engine 514 may be configured to select the wireless communication technology according to various selection criterion. For example, the channel scanning engine 514 may be configured to select the wireless communication technology based on specifications of the respective transceiver(s) (e.g., scan time, filters, sensitivity, channel bandwidth, and so forth). As one example, the channel scanning engine 514 may be configured to select the wireless communication technology based on the corresponding transceiver having a shortest scan time, to perform the initial channel assessment quickest, relative to other wireless communication technologies supported by the device 502, 504. As another example, the channel scanning engine 514 may be configured to select the wireless communication technology based on the corresponding transceiver having the greatest sensitivity, to perform the initial channel assessment most accurately, relative to other wireless communication technologies supported by the device 502, 504.

To perform the initial channel assessment, the channel scanning engine 514 may be configured to hop to, switch to, or otherwise listen on a given channel, for any given signals received on the channel and sent by a neighboring device. The channel scanning engine 514 may be configured to perform scans on 20 MHz channels of the frequency spectrum (e.g., frequency spectrum(s) that may be used or occupied by neighboring WLAN devices), to identify any energy (e.g., from a received signal) detected on the channel. In some embodiments, the channel scanning engine 514 may be configured to perform a scan for a scan duration. The scan duration may be set, determined, or otherwise configured according to a minimum burst frequency for WLAN technology. For example, where the minimum burst frequency 45 Hz, the scan duration for a particular 20 MHz channel may be approximately 22 milliseconds (ms). In this regard, the scan duration for the frequency spectrum which is to be scanned, may be equal to the number of 20 MHz channels (e.g., that may be occupied by WLAN devices) multiplied by the scan duration for a particular 20 MHz channel (e.g., if the number of 20 MHz channels that may be occupied is 31 channels, then the total scan duration may be equal to approximately 682 ms).

Several different options for performing the scan are described in greater detail below in connection with Table 1, and are based on the particular type of wireless communication technology, scan durations, and/or other metric(s). The UNII-1 band may have a total bandwidth of 100 MHz, the UNII-3 frequency band described above may have a total bandwidth of 125 MHz, the UNII-4 frequency band may have a total bandwidth of 45 MHZ, and the UNII-5 frequency band may have a total bandwidth of 500 MHz. In instances in which only UNII-3 and UNII-5 are available (for example, due to regulatory constraints), for WPAN technologies which use 2 MHz NB channels, there may be 313 possible 2 MHz NB channels (e.g., 63 in UNII-3 and 240 in UNII-5). For WPAN technologies which use 2.5 MHz NB channels, there may be 300 channels are defined (e.g., 50 channels in UNII-3 and 200 channels in UNII-5) as defined below, showing computation of the center frequency, where k is the channel number:

$${f}_{c} = 5726.25 + k \times 2.5 in MHz for k = 0 , … , 49$$

$${f}_{c} = 5926.25 + ( k - 50 ) \times 2.5 in MHz for k = 50 , … , 249$$

In Table 1 below, presented are different options which may result in different amounts of power consumption (as compared to BLUETOOTH, or 2.4 GHz NB scanning for reference).

TABLE 1
Options for Performing Scans

| | | UNII 5 | UNII-3 | UNII-3 + UNII-5 | UNII-3 + UNII-5 |
|---|---|---|---|---|---|
| | | (assume | (assume | (assume | (assume |
| | | 10 mW RX | 10 mW RX | 10 mW RX | 10 mW RX |
| | 2.4 GHz | power) | power) | power) | power) |
| | (reference) | [option 1] | [option 1] | [option 2] | [option 3] |
| Listen on | 250 | 1/Fv*NB_BW_MHz/ | 1/Fv*NB_BW_MHz/ | 1/Fv*NB_BW_MHz/ | 1/Fv*NB_BW_MHz/ |
| each channel | | 160 = 174 us | 80 = 347 us | 20 = 1389 us | 80 = 347 us |
| (us) | | when | when | when | when |
| | | NB_BW_MHz = | NB_BW_MHz = | NB_BW_MHz = | NB_BW_MHz = |
| | | 2 | 2 | 2 | 2 |
| Number of | 40 | 500/NB_BW_MHz = | 125/NB_BW_MHz = | 625/NB_BW_MHz = | 625/NB_BW_MHz = |
| channels | | 250 when | 63 when | 313 when | 313 when |
| (NOC) | | NB_BW_MHz = | NB_BW_MHz = | NB_BW_MHz = | NB_BW_MHz = |
| | | 2 | 2 | 2 | 2 |
| Total | 10 | 1/Fv*500/ | 1/Fv*125/ | 1/Fv*625/ | 1/Fv*625/ |
| Duration | | 160*1000 = | 80*1000 = | 20*1000 = | 80*1000 = |
| (ms) | | 43.4 | 21.70 | 434 | 108.5 |
| Additional | 240 with | 434/ASI | 217/ASI | 4340/ASI | 1085/ASI |
| Power | adaptive | | | | |
| Consumption | frequency | | | | |
| (uW) | hopping | | | | |
| | (AFH) scan | | | | |
| | interval | | | | |
| | (ASI) = 1 | | | | |
| | second | | | | |

With Option 1, adding an additional 651/ASI uW (434 uW for UNII-5 and 217 uW for UNII-3) of power consumption, the time spent on a single 20/40/80/160 MHz channel is 1.75/3.5/7/14 ms in UNII-5. The AFH scan interval (ASI) may be in units of seconds. To have comparable power consumption relative to a listen-before-talk-based system or solution, the ASI may be set to greater than or equal to six for Option 1. In UNII_3, with Option 1, the time spent on a single 20/40/80 MHz channel is 3.5/7/14 milliseconds (ms). With a burst frequency (e.g., WLAN burst frequency, Fv) equal to a 72 Hz burst duration, a WLAN burst may be detected every 14 ms. Therefore, for WLAN bursty signals with >=72 Fv Hz, in Option 1, each burst may be captured for 160 MHz WLAN in UNII-5 and for 80 MHz WLAN in UNII-3.

Option 2 may be configured to capture 20 MHz bursts at every UNII-3 and UNII-5 channel that are sent at <=1/Fv cadence. One drawback with Option 2 is the ˜4.34 mW (˜7× greater than Option 1) increase in power consumption and total duration. In this regard, Option 2 may be used in initialization (e.g., as part of the initial channel assessment), or in between calls or streaming. To use Option 2 with the same power consumption as Option 1 and/or listen-before-talk-based systems or solutions, the ASI may be set to a value greater than or equal to 40, for example. Another solution may include executing a scan according to Option 2 every fixed interval (e.g., every minute), for example.

Option 3 is similar to Option 1 except that it addresses 80 MHz in UNII-5. In order to have the same power consumption as Option 1 and/or listen-before-talk-based systems or solutions, the ASI may be set to a value greater than or equal to 10, for example.

Some solutions may involve a device (e.g., a NB device) to detect and move away from affected NB channel within 500 ms. One way to reduce power consumption and expedite the total scan duration is to sample every Kth (e.g., K=4) sub-channel so that the 4.34 mW additional power consumption value of Option 2 goes to ˜1 mW. The m-th scan would sample channels mod(m,K)+1+K*n, where n is 0, 1, 2, . . . . In other words, for the K=4 example, the first scan (m=0) may include scanning channels 1, 5, 9, . . . ; the second scan (m=1) may include scanning channels 2, 6, 10, . . . ; the third scan (m=2) may include scanning channels 3, 7, 11, . . . ; the fourth scan (m=3) may include scanning channels 4, 8, 12, . . . ; and the fifth scan (m=4) may include returning to scanning channels 1, 5, 9, . . . . Another consideration is to use another wireless communication technology (e.g., a WLAN communication technology, such as a 20 MHz WLAN communication technology) to perform the scan, so as to reduce latency seen by high priority NB traffic. In an example where only UNII-3 and UNII-5 are available, there may be 30 channels (20 MHz channels) in UNII-3 and UNII-5 (e.g., 25 channels in UNII-3 and 5 channels in UNII-5). If the channel scanning engine 514 scans each channel for 1/Fv seconds, the scan on both UNII-3 and UNII-5 would be completed in 30/Fv=417 ms (when Fv=72), which is similar to the duration of Option 2.

In some embodiments, the channel scanning engine 514 may be configured to split/partition the scan into various segments. For example, Option 1 has total duration of 65.1 ms. The channel scanning engine 514 may be configured to split the 65.1 ms duration into seven ˜10 ms scans. Additionally or alternatively, in some embodiments, instead of spending consecutive time in each 20 MHz channel, the channel scanning engine 514 may be configured to jump from one 20 MHz channel to another after each sub-channel is scan. In the UNII-3 and UNII-5 full scan example using Option 2, the channel scanning engine 514 may be configured to scan R (e.g. R=1) sub-channels in each 20 MHz channel, thereby reducing the scan time by a factor of 30. When Fv=72, the 434 ms scan duration would be reduced to 434/30*R=14.47 ms, which may be an acceptable scan duration in the middle of voice/video traffic. In order to get a full scan, the channels (e.g., which are scanned) could be staggered. Additionally or alternatively, the channel scanning engine 514 may be configured to select or otherwise determine the scan duration for each sub-channel and channel. For example, if the channel scanning engine 514 sets the scan duration for each channel to 0.96 ms (in the above example), then the total scan duration may be ˜10 ms.

The channel scanning engine 514 may be configured to perform the scan on individual sub-channels (or subcarriers, segments, etc.) within a given scan of a 20 MHz channel. The channel scanning engine 514 may be configured to identify, register, determine, or otherwise detect one or more metrics for a particular sub-channel, in connection with performing the scan of the sub-channel. The channel scanning engine 514 may be configured to compare detected metric(s) to corresponding key performance indicator (KPI) metric(s), for labeling the sub-channel as occupied/unavailable. In some embodiments, the detected metric(s) may be or include a signal strength, an energy level, etc. on a particular channel.

In some embodiments, the channel scanning engine 514 may be configured to determine the KPI metric(s) to which the detected metric(s) are to be compared. For example, the KPI metric(s) may be or include a threshold in which to compare the detected metric(s). The channel scanning engine 514 may be configured to select/identify, or otherwise determine the KPI metric(s) based on the wireless communication technology which was selected for performing the initial channel assessment. In some embodiments, the channel scanning engine 514 may be configured to determine the KPI metric(s) according to the type of wireless communication technology and a fixed metric. The fixed metric may be, for example, a probability of detection on a channel which satisfies a threshold criterion (e.g., greater than or equal to 90% probability of detection on a channel).

The channel scanning engine 514 may be configured to determine the KPI metric(s) for a particular type of wireless communication technology, such that each type of wireless communication technology uses (potentially) different KPI metrics which result in/satisfy the same fixed metric. In this regard, the channel scanning engine 514 may be configured to determine the KPI metric(s) for a particular scan (e.g., using a particular wireless communication technology), to normalize results of the scan relative to different wireless communication technologies and/or different hardware which may be deployed on a respective device 502, 504. For example, assuming the KPI metric is an energy detection threshold and further assuming that a WLAN communication technology has a more sensitive antenna (e.g., more likely to detect energy of a signal from a source device) than a WPAN communication technology, the channel scanning engine 514 may be configured to select a higher energy detection threshold if the WLAN communication technology is used for performing the scan as compared to the energy detection threshold should the WPAN communication technology be used. In these examples, the energy detection threshold may be, for example, −75 dBm/MHz or −85 dBm/MHz (which may be a function of the maximum transmit power for the corresponding wireless communication technology), though other thresholds may be used, to increase/decrease sensitivity and/or to increase/decrease scan duration.

The first device 502 may include a channel map engine 516. The channel map engine 516 may be designed or configured to establish, maintain, determine, derive, produce, or otherwise generate a channel map of the scanned channels. The channel map may be or include a table, structured dataset, or other record which identifies a state (e.g., a channel state) for each of the channels which are scanned. In some embodiments, prior to performing the initial channel assessment, the channel map engine 516 may be configured to set each channel with a first channel state. As the scan is performed, and based on the comparison of the detected metric(s) for a particular channel to the KPI metric(s), the channel map engine 516 may be configured to update (as needed) the channel state for each respective channel scanned. In some embodiments, the channel states may include, for example, an occupied channel state, a potentially occupied channel state, and/or an available channel state. These states, along with the corresponding criterion for selecting the state for a particular channel, are described in greater detail below.

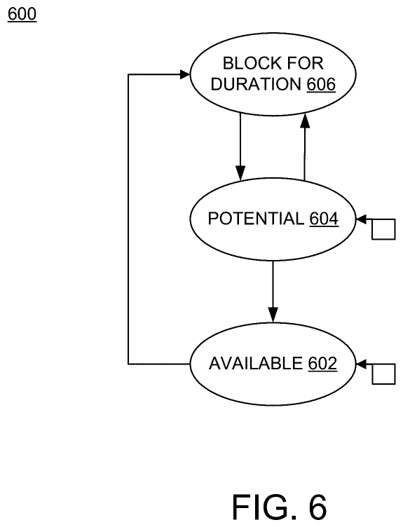

Referring to FIG. 6, depicted is a state diagram 600 showing selection between different channel states, according to an example implementation of the present disclosure. As described above, at least initially, each of the channels which are scanned may be set to a first channel state (e.g., an available channel state). In this regard, the channel map engine 516 may initialize the channel map based on an assumption that each channel is available (or unoccupied/unblocked). In connection with the scan of each channel, the channel map engine 516 may be configured to update the channel map to indicate or identify blocked (or occupied) channels, and potentially blocked or occupied channels, as described in greater detail below.

In some embodiments, the channel map engine 516 may be configured to determine the channel state for individual sub-channels. The channel map engine 516 may be configured to determine the channel state for an individual sub-channel based on the comparison of the metric(s) for the sub-channel to the KPI metric(s). For example, the channel map engine 516 may be configured to determine the channel state for an individual sub-channel, based on detected interference for (e.g., energy detected on) the sub-channel as compared to the energy detection threshold. Where the detected metric(s) satisfy the KPI metric(s), the channel map engine 516 may be configured to determine that interference is detected, and thus label the sub-channel as occupied/blocked.

In some embodiments, the channel map engine 516 may be configured to determine the channel state for an individual sub-channel based on a count of ranging/packet failures/packet error rate (e.g., failure condition). For example, where a particular sub-channel is occupied and used for ranging operations (or packet transmission/receptions), the channel map engine 516 may be configured to maintain a count of failures on the sub-channel. The count of failures may be, for example, consecutive failures (e.g., failures which do not have any intervening successful operations). The channel map engine 516 may be configured to compare the count of failures to a threshold value (e.g., three consecutive ranging failures, three consecutive packet failures, a packet error rate of greater than or equal to a threshold percentage over a time period, though any threshold/threshold rate may be used). The channel map engine 516 may be configured to determine that the sub-channel is occupied responsive to the failure condition satisfying the threshold criterion (e.g., being greater than or equal to the threshold).

In some embodiments, the channel map engine 516 may be configured to determine the channel state for a particular channel, based on the determined channel state(s) for a plurality of sub-channels included in the channel. In some embodiments, to determine that a channel is blocked, the channel map engine 516 may be configured to determine a channel state for each or at least some of the sub-channels within a particular 20 MHz channel. For example, and in some embodiments, if one or more sub-channels belonging to the same 20 MHz channel determined to be unavailable or blocked (e.g., based on the detected metric(s) [such as the energy detection level] satisfying a criterion [such as being greater than or equal to] corresponding to the KPI metric(s) [such as the energy detection threshold]), then each of the sub-channels in the same 20 MHz channel may be determined to be unavailable or blocked. In other words, if any sub-channel belonging to a segment/channel is determined to be blocked, then each of the other sub-channels in the same segment/channel may also be determined to be blocked. As another example, and in some embodiments, if a certain percentage of the sub-channels belonging to the same 20 MHz channel are determined to be blocked, then all of the sub-channels in the same segment may also be determined to be blocked. The probability detection on each occupied 20 MHz channel may be greater than or otherwise satisfy a threshold probability (e.g., a percentage threshold, such as 99%).

In this regard, at state 602, each of the channels and sub-channels may be initially set as available. In response to interference being detected on a sub-channel, the sub-channel may be labeled/determined to be occupied, and the sub-channel may be moved to state 606, where the sub-channel is labeled as blocked for a duration of time (e.g., a block duration, such as three seconds, five seconds, ten seconds, etc.). Additionally, where the error rate for a particular sub-channel satisfy a threshold criterion (e.g., packet error rate greater than or equal to a threshold percentage, consecutive packet or ranging failures greater than or equal to a threshold count, and so forth), the sub-channel may be labeled/determined to be occupied, and the sub-channel may be moved to state 606, where the sub-channel is labeled as blocked for a duration of time. Further, and in some embodiments, where a threshold number of sub-channels (e.g., neighboring NB channels (NNCs)) within a channel are labeled as blocked (e.g., one or more sub-channels labeled as blocked, greater than 30% of sub-channels labeled as blocked, and so forth), the remaining sub-channels may be labeled as blocked for the block duration. Channels and sub-channels which are initially scanned and do not satisfy any of the blocked criteria described above may be maintained as available.

Following the block duration, the sub-channel(s) may move to the potential (e.g., potentially blocked) state 604. In the potentially blocked state, if interference is detected on the sub-channel (e.g., in a subsequent state), the sub-channel may be moved back to the blocked state for the block duration. If interference is not detected for N consecutive measurements, and if each of the sub-channels in the same channel are labeled as either “potential” or “available”, the channel may be moved to “available” state.

The first device 502 may include a channel selection engine 518. The channel selection engine 518 may be designed or configured to select, determine, or otherwise identify channel(s) which may be occupied by the first device 502. In some embodiments, the channel selection engine 518 may be configured to select channels to occupy based on or according to the channel map. The channel selection engine 518 may be configured to select channels to occupy, based on which channel(s) have a channel state of available. The channel selection engine 518 may be configured to occupy the selected channels, for wireless communication via one or more NB wireless communication technologies. For example, the channel selection engine 518 may be configured to occupy a selected channel for performing ranging operations, packet or data transmission/exchange, etc.

In some embodiments, the channel map engine 516 may be configured to push, communicate, transmit, or otherwise provide the channel map to each of the peripheral devices 504. In some embodiments, the channel map engine 516 may be configured to provide the channel map to each of the peripheral devices 504, such that the peripheral devices 504 may be configured to camp/hop to/occupy available channels according to the channel map. In some embodiments, as subsequent channel assessments are performed by the first device 502 (e.g., triggered by the channel scanning engine 514 as described herein), the channel map engine 516 may be configured to update the channel map based on such subsequent scans. The channel map engine 516 may be configured to push the updated channel map (e.g., as a delta from the previous channel map, or a new channel map) to the peripheral devices 504 for use thereby.

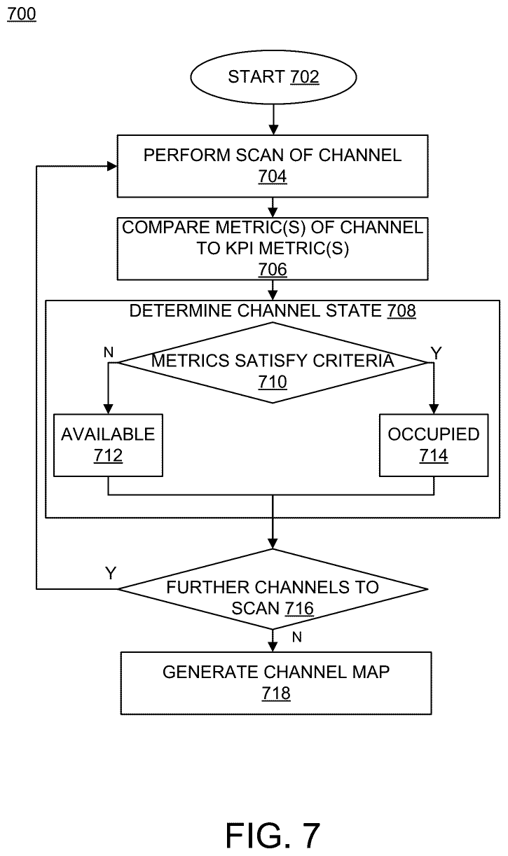

Referring now to FIG. 7, depicted is a flowchart showing an example method 700 of generating a channel map based on detected metric(s), according to an example implementation of the present disclosure. The method 700 may be performed, executed, or otherwise implemented on the devices, components, elements, and/or hardware described above with reference to FIG. 1-FIG. 6. As a brief overview, at step 702, the method 700 may begin. At step 704, a first device may perform a scan of a channel. At step 706, the first device may compare metric(s) of the scan to a KPI metric. At step 708, the first device may determine a channel state for the channel. At step 716, the first device may determine whether further channels are to be scanned. At step 718, the first device may generate a channel map using the channel states.

At step 702, the method 700 may begin. In some embodiments, the method 700 may begin when the first device is to establish a connection or occupy a channel for performing a ranging/packet exchange/data transmission with another device. In some embodiments, when the method 700 begins at step 702, each of the channels (e.g., of the channel map) may be set to an “available” channel state. In other words, when the method 700 begins, the channel map may be initialized to show or identify each channel as being available for occupation by the first device.

At step 704, a first device may perform a scan of a channel. In some embodiments, the first device may perform a scan of a channel in connection with an initial channel assessment of a plurality of channels. The first device may perform the scan of a plurality of sub-channels of a channel, in connection with scanning the channel. In other words, performing the scan may include scanning both channels and sub-channels of a given channel. To perform a scan, the first device may listen on the channel for a particular duration. The duration may correspond to a burst frequency of a wireless communication technology (e.g., a WLAN burst frequency, or Fv described above). The first device may perform the scan by identifying a power or energy of signal(s) detected or otherwise identified on the channel while listening for the duration.

At step 706, the first device may compare metrics of the scan to a KPI metric. In some embodiments, the first device may compare detected metric(s) for the channel (e.g., the power or energy detected/identified on the channel) to corresponding KPI metric(s). As described above, the KPI metric(s) may defined/configured/established/determined based on the wireless communication technology used to perform the scan (e.g., to normalize scans for different wireless communication technologies and hardware specifications).

At step 708, the first device may determine a channel state for the channel. In some embodiments, determining the channel state may include determining (e.g., at step 710) whether the metric(s) (e.g., detected metrics in connection with the scan) satisfy a criteria (e.g., corresponding to the KPI metric). For example, at step 710, the first device may compare the detected energy for the channel to an energy detection threshold KPI metric, and determine whether the detected energy is greater than or equal to the energy detection threshold KPI metric. Where the detected energy does not satisfy the criteria corresponding to the KPI metric (e.g., the detected energy is less than or equal to the energy detection threshold KPI metric), the channel may be labeled as available (step 712). Where the detected energy satisfies the criteria corresponding to the KPI metric (e.g., the detected energy is greater than or equal to the energy detection threshold KPI metric, the channel may be labeled as occupied (step 714).

In some embodiments, where step 708 is performed per sub-channel for a respective channel (e.g., a 20 MHz channel), step 710 may involve determining additional metric(s) for the channel state of the sub-channels satisfy a corresponding criteria. For example, the additional metric(s) may include a count of sub-channels marked or labeled as occupied. In this example, the criteria may be a threshold count (e.g., one sub-channel labeled as occupied, a percentage of sub-channels labeled as occupied). Continuing this example, where the count of sub-channels marked or labeled as occupied satisfies the threshold count (e.g., is greater than or equal to the threshold/threshold percentages), the remaining sub-channels of the channel (e.g., the neighboring narrowband channels within the same 20 MHz channel) may be labeled as occupied at step 714.

At step 710, the first device may determine whether further channels are to be scanned. Where further channels are to be scanned as part of the initial (or any subsequent) channel assessment, the method 700 may loop back to step 702, where the first device performs a scan of the next channel which is to be scanned. In this regard, steps 702 through 714 may be repeated for each channel and sub-channel, to determine the channel state for the channels and sub-channels. Once each of the channels are scanned (e.g., such that no further channels are to be scanned at step 716), the method 700 may proceed to step 718.

At step 718, the first device may generate a channel map using the channel states. In some embodiments, the first device may generate the channel map by populating an identifier corresponding to each channel (and sub-channel as appropriate) and the associated channel state of the channel. The first device may generate the channel map to identify the channel state for each of the channels scanned at step 702.

In some embodiments, following completion of a first instance, the method 700 may be re-executed. For example, the method 700 may be re-executed by the first device to update the channel map. The method 700 may be re-executed by scanning each of the available channels and any channels which (e.g., after a duration following the channel was labeled as occupied at step 714) are labeled as potentially occupied. The method 700 may be re-executed to determine whether the available channels are still to be labeled as available, and whether the potentially occupied channels are now available. The method 700 may be re-executed to generate an updated channel map.

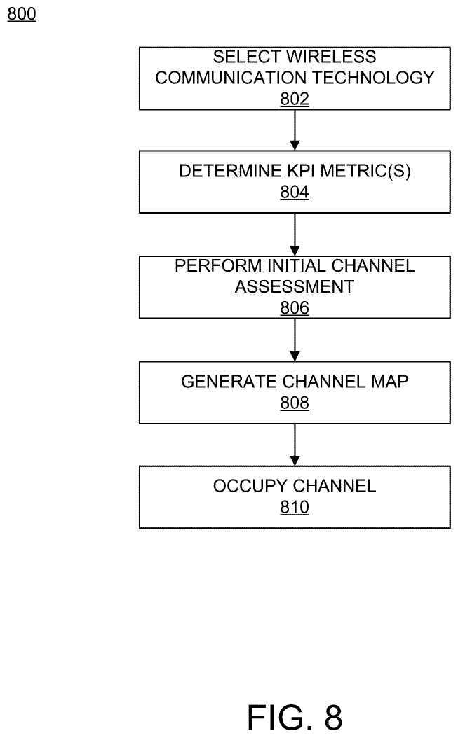

Referring now to FIG. 8, depicted is a flowchart showing an example method 800 of adaptive frequency hopping, according to an example implementation of the present disclosure. The method 800 may be performed, executed, or otherwise implemented on the devices, components, elements, and/or hardware described above with reference to FIG. 1-FIG. 6. As a brief overview, at step 802, a first device may select a wireless communication technology. At step 804, the first device may determine one or more KPI metrics. At step 806, the first device may perform an initial channel assessment. At step 808, the first device may generate a channel map. At step 810, the first device may occupy a channel.

At step 802, a first device may select a wireless communication technology. In some embodiments, the first device may select a wireless communication technology to perform an initial channel assessment. The first device may select the wireless communication technology from one or more wireless communication technologies supported by the first device. For example, where the first device supports multiple wireless communication technologies (e.g., WLAN communication technology, WPAN communication technologies, etc.), the first device may select the wireless communication technology from those wireless communication technologies supported by the first device. The first device may select the wireless communication technology based on or according to various specifications of the technology (e.g., scan speed, hardware specifications, filtering sensitivity, energy detection capabilities, etc.).

At step 804, the first device may determine one or more KPI metrics. In some embodiments, the first device may determine one or more KPI metrics which are to be used for performing the initial channel assessment. The first device may determine the KPI metric(s) according to the wireless communication technology selected at step 802. For example, the KPI metric(s) may include KPI metrics for a first wireless communication technology and KPI metrics for second wireless communication technology, where the respective KPI metrics are set according to a fixed metric (e.g., to normalize the channel assessment across different wireless communication technologies and hardware specifications). The fixed message may be, for instance, a probability of detection of an occupied channel. The KPI metric may be, for instance, an energy detection threshold. In this regard, the first device may determine the KPI metric based on a type of the wireless communication technology selected to perform the initial channel assessment.

At step 806, the first device may perform an initial channel assessment. In some embodiments, the first device performs the initial channel assessment across a plurality of channels, using the wireless communication technology selected for performing the scan. At step 808, the first device may generate a channel map. In some embodiments, the first device may generate the channel map for the plurality of channels scanned at step 806, where the channel map identifies a channel state for the plurality of channels, based on a comparison of one or more metrics for the channels as compared to one or more key performance indicator (KPI) metrics set according to the wireless communication technology. Steps 806 and 808 may include various steps from the method 700 described above with reference to FIG. 7, and using the KPI metric(s) determined at step 804.

In some embodiments, following generating the channel map, the first device may share, communicate, send, provide, or otherwise transmit the channel map with one or more other devices communicably coupled to the first device. For example, the first device may transmit the channel map to peripheral devices which are communicably coupled to the first device. Additionally, and in some embodiments, the first device may share the channel map with local hardware device(s) of the first device. For example, the first device may perform the initial channel assessment using a first wireless communication technology (e.g., a WLAN communication technology of the first device), and may share the channel map with another wireless communication technology (e.g., a WPAN communication technology of the first device) for use thereby.

At step 810, the first device may occupy a channel. In some embodiments, the first device may occupy a channel of the plurality of channels, based on the channel state of the channel in the channel map. The first device may occupy the channel for performing ranging operations, for performing data/packet exchange, etc., with another device. The first device may occupy the channel with the wireless communication technology selected to perform the initial channel assessment (e.g., at step 802), and/or with a different wireless communication technology other than that selected to perform the initial channel assessment. Additionally, where other peripheral device(s) receive the channel map, the peripheral device(s) may also occupy a channel according to the channel map.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
performing, by a wireless communication device, an initial channel assessment across a plurality of channels, using a wireless communication technology of a plurality of wireless communication technologies supported by the wireless communication device;
generating, by the wireless communication device, a channel map for the plurality of channels, for identifying a channel state for the plurality of channels, based on a comparison of one or more metrics for the channels as compared to one or more key performance indicator (KPI) metrics set according to the wireless communication technology; and
occupying, by the wireless communication device, a channel, of the plurality of channels, based on the channel state of the channel in the channel map.

2. The method of claim 1, further comprising:
selecting, by the wireless communication device, the wireless communication technology from the plurality of wireless communication technologies supported by the wireless communication device, to perform the initial channel assessment.

3. The method of claim 2, wherein the plurality of wireless communication technologies comprise at least one of a 20 megahertz (MHz) wireless local area network (WLAN) communication technology, a first personal area network (PAN) technology, or a second PAN technology.

4. The method of claim 3, wherein the first PAN technology supports 2.5 MHz communication, and the second PAN technology supports at least one of 2 MHz communication or 4 MHz communication.

5. The method of claim 1, wherein the one or more KPI metrics comprise one or more first KPI metrics for a first wireless communication technology and set according to a fixed metric, and one or more second KPI metrics for a second wireless communication technology and set according to the fixed metric.

6. The method of claim 5, further comprising determining, by the wireless communication device, the one or more KPI metrics according to the fixed metric, based on a type of the wireless communication technology selected to perform the initial channel assessment.

7. The method of claim 1, wherein the channel state is identified from a plurality of channel states comprising an occupied channel state, a potentially occupied channel state, or an available channel state.

8. The method of claim 1, wherein the channel state for a respective channel is identified as an occupied channel state, responsive to at least one of:
the one or more metrics for the respective channel indicating interference being detected on the respective channel,
a count of neighboring narrowband channels (NNCs) having respective metrics indicating interference being detected satisfying a first threshold criterion, or
a count of consecutive ranging failures satisfying a second threshold criterion.

9. The method of claim 1, wherein the wireless communication device comprises a central device, the method further comprising:
transmitting, by the central device, the channel map to one or more peripheral devices communicably coupled to the central device.

10. The method of claim 1, further comprising:
determining, by the wireless communication device, for a first subset of channels of the plurality of channels having a potentially occupied channel state, and for a second subset of channels of the plurality of channels having an available channel state, to perform one or more subsequent channel assessments;
performing, by the wireless communication device, for the first subset and the second subset, one or more subsequent channel assessments; and
updating, by the wireless communication device, the channel map according to the one or more subsequent channel assessments.

11. The method of claim 1, further comprising:
after a predetermined duration following designation of one or more channels of the plurality of channels as having an occupied channel state,
performing, by the wireless communication device, one or more subsequent channel assessments for the one or more channels; and
updating, by the wireless communication device, the channel map according to the one or more subsequent channel assessments.

12. A wireless communication device, comprising:
one or more wireless transceivers configured to support one or more of a plurality of wireless communication technologies; and
one or more processors configured to:
perform, using the one or more transceivers, via a wireless communication technology of the plurality of wireless communication technologies, an initial channel assessment across a plurality of channels;
generate a channel map for the plurality of channels, that identifies a channel state for the plurality of channels, based on a comparison of one or more metrics for the channels as compared to one or more key performance indicator (KPI) metrics set according to the wireless communication technology; and
occupy, via the one or more transceivers, a channel, of the plurality of channels, based on the channel state of the channel in the channel map.

13. The wireless communication device of claim 12, wherein the one or more processors are configured to:
select the wireless communication technology from the plurality of wireless communication technologies supported by the wireless communication device, to perform the initial channel assessment.

14. The wireless communication device of claim 12, wherein the plurality of wireless communication technologies comprise at least one of a 20 megahertz (MHz) wireless local area network (WLAN) communication technology, a first personal area network (PAN) technology, or a second PAN technology.

15. The wireless communication device of claim 14, wherein the first PAN technology supports 2.5 MHz communication, and the second PAN technology supports at least one of 2 MHz communication or 4 MHz communication.

16. The wireless communication device of claim 12, wherein the one or more KPI metrics comprise one or more first KPI metrics for a first wireless communication technology and set according to a fixed metric, and one or more second KPI metrics for a second wireless communication technology and set according to the fixed metric.

17. The wireless communication device of claim 12, wherein the channel state is identified from a plurality of channel states comprising an occupied channel state, a potentially occupied channel state, or an available channel state.

18. The wireless communication device of claim 12, wherein the channel state for a respective channel is identified as an occupied channel state, responsive to at least one of:
the one or more metrics for the respective channel indicating interference being detected on the respective channel,
a count of neighboring narrowband channels (NNCs) having respective metrics indicating interference being detected satisfying a first threshold criterion, or
a count of consecutive ranging failures satisfying a second threshold criterion.

19. The wireless communication device of claim 12, wherein the wireless communication device comprises a central device, and wherein the one or more processors are configured to:
transmit, via the one or more transceivers, the channel map to one or more peripheral devices communicably coupled to the central device.

20. A non-transitory computer readable medium storing instructions that, when executed by one or more processors, cause the one or more processors to:
perform, via a wireless communication technology of a plurality of wireless communication technologies supported by a wireless communication device, an initial channel assessment across a plurality of channels;
generate a channel map for the plurality of channels, to identify a channel state for the plurality of channels, based on a comparison of one or more metrics for the channels as compared to one or more key performance indicator (KPI) metrics set according to the wireless communication technology; and
occupy a channel, of the plurality of channels, based on the channel state of the channel in the channel map.
